(19) United States
(12) Patent Application Publication
(10) Pub. No.: US 2015/0010236 A1
(43) Pub. Date: Jan. 8, 2015

(54) AUTOMATIC IMAGE REFOCUSING METHOD

(71) Applicant: HTC CORPORATION, Taoyuan City (TW)

(72) Inventors: Ruey-Jer CHANG, Taoyuan City (TW); Lun-Cheng CHU, Taoyuan City (TW); Chi-Pang CHIANG, Taoyuan City (TW); Wei-Chung YANG, Taoyuan City (TW)

(21) Appl. No.: 13/936,501

(22) Filed: Jul. 8, 2013

(51) Int. Cl. G06K 9/46; G06T 5/00

(52) U.S. Cl. CPC G06K 9/46; G06T 5/003
USPC 382/195

(57) ABSTRACT

An automatic image adjusting method for use in an electronic device is provided. The electronic device has a processor and a display screen. The automatic image adjusting method has the following steps of: analyzing an image to determine multiple target objects in the image; estimating corresponding depth distances of the target objects; and displaying the image on the display screen by switching focus between the target objects according to the corresponding depth distances in a display order.

### CROSS REFERENCE TO RELATED APPLICATIONS

### BACKGROUND OF THE INVENTION

1. Field of the Invention

The present invention relates to image adjustment, and in particular, relates to an electronic device and an automatic image refocusing method capable of illustrating a photo slideshow by automatically refocusing on objects at different depth distances.

2. Description of the Related Art

Currently, electronic devices, such as smart phones and tablet PCs, have become more and more popular. When viewing a picture comprising several people in a scene, each of the people may be located at different depth distances within the scene (or distance from the lens of the camera). However, a conventional electronic device can not use the depth information in the picture to focus and refocus on different people in the picture, and thus user experience for viewing a picture cannot be enhanced from a conventional image.

### BRIEF SUMMARY OF THE INVENTION

A detailed description is given in the following embodiments with reference to the accompanying drawings.

In an exemplary embodiment, an automatic image adjusting method for use in an electronic device is provided. The electronic device comprises a processor and a display screen. The automatic image adjusting method comprises the following steps of: analyzing an image to determine multiple target objects in the image; estimating corresponding depth distances of the target objects in the image; and displaying the image on the display screen by switching focus between the target objects according to the corresponding depth distances in a display order.

In another exemplary embodiment, an electronic device is provided. The electronic device comprises: a display screen configured to display an image; and a processor configured to analyze an image to determine multiple target objects in the image, estimate corresponding depth distances of the target object in the image, and switch focus of the image between the target objects according to the corresponding depth distances in a display order.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an electronic device 100 according to an embodiment of the invention;

FIGS. 2A˜2D are diagrams illustrating the refocusing operations in an image according to an embodiment of the invention; and

FIG. 3 is a flow chart illustrating the automatic image adjusting method according to an embodiment of the invention

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

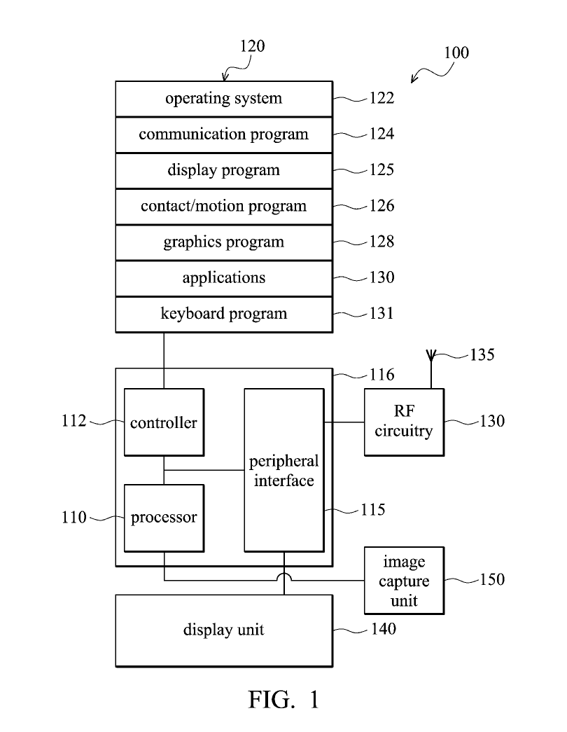

FIG. 1 is a schematic diagram illustrating an electronic device 100 according to an embodiment of the invention. The electronic device 100 may comprise a processor 110, a memory unit 120, a display screen 140, and an image capture unit 150. In an exemplary embodiment, the electronic device 100 may be a personal computer or portable device such as mobile phone, tablet, digital camera/camcorder, game console or any suitable device equipped with image recording function. The processor 110 may be data processors, image processors, application processor and/or central processors, and is capable of executing one or more types of computer readable medium stored in the memory unit 120. Specifically, the electronic device 100 may further comprise an RF circuitry 130. In the embodiments, the display screen 140 may be a touch-sensitive screen.

In addition, the RF circuitry 130 may be coupled to one or more antennas 135 and may allow communications with one or more additional devices, computers and/or servers via a wireless network. The electronic device 100 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto.

When the display screen 140 is implemented as a touch-sensitive screen, it may detect contact and any movement or break thereof by using any of a plurality of touch sensitivity technologies now known or to be later developed, including, but not limited to, capacitive, resistive, infrared, and surface acoustic wave touch sensitivity technologies, as well as other proximity sensor arrays or other elements for determining one or more points of contact with the touch-sensitive screen. However, the touch-sensitive screen may also display visual output of the electronic device 100. In some other embodiments, the electronic device 100 may include circuitry (not shown in FIG. 1) for supporting a location determining capability, such as that provided by a Global Positioning System (GPS).

The image capture unit 150 may be one or more optical sensors configured to capture images. For example, the image capture unit 150 may be one or more CCD or CMOS sensors, but the invention is not limited thereto.

The memory unit 120 may comprise one or more types of computer readable medium. The memory unit 120 may be high-speed random access memory (e.g. SRAM or DRAM) and/or non-volatile memory, such as flash memory (for example embedded multi-media card). The memory unit 120 may store program codes of an operating system 122, such as LINUX, UNIX, OS X, Android, iOS or WINDOWS operating system, or an embedded operating system such as VxWorks therein. The operating system 122 may executes procedures for handling basic system services and for performing hardware dependent tasks. The memory unit 120 may also store communication programs 124 for executing communication procedures. The communication procedures may be used for communicating with one or more additional devices, one or more computers and/or one or more servers. The memory unit 120 may comprise display programs 125, contact/motion programs 126 to determine one or more points of contact and/or their movement, and a graphics processing programs 128. The graphics processing programs 128 may support widgets, i.e., modules or applications with embedded graphics. The widgets may be implemented using JavaScript, HTML, Adobe Flash, or other suitable computer programming languages and technologies.

The memory unit 120 may also comprise one or more application programs 130. For example, application programs stored in the memory unit 120 may be telephone applications, email applications, text messaging or instant messaging applications, memo pad applications, address books or contact lists, calendars, picture taking and management applications, and music playback and management applications. The application programs 130 may comprise a web browser (not shown in FIG. 1) for rendering pages written in the Hypertext Markup Language (HTML), Wireless Markup Language (WML), or other languages suitable for composing web pages or other online content. The memory unit 120 may further comprise keyboard input programs (or a set of instructions) 131. The keyboard input programs 131 operates one or more soft keyboards.

It should be noted that each of the above identified programs and applications correspond to a set of instructions for performing one or more of the functions described above. These programs (i.e., sets of instructions) need not be implemented as separate software programs, procedures or modules. The various programs and sub- programs may be rearranged and/or combined. Various functions of the electronic device 100 may be implemented in software and/or in hardware, including one or more signal processing and/or application specific integrated circuits.

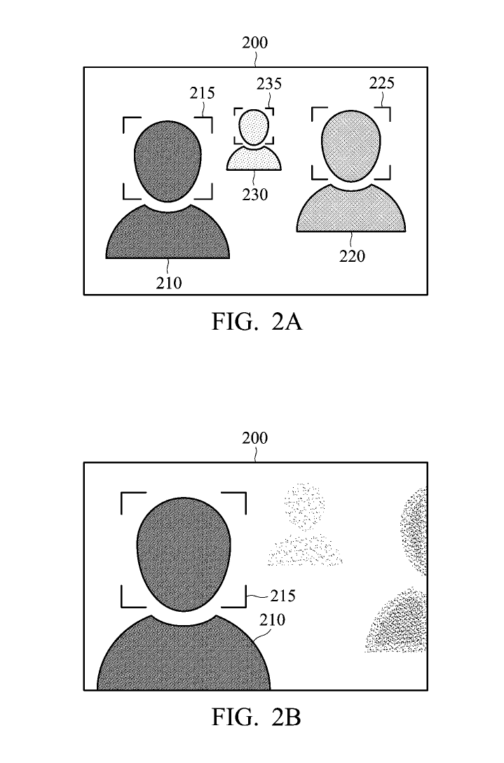

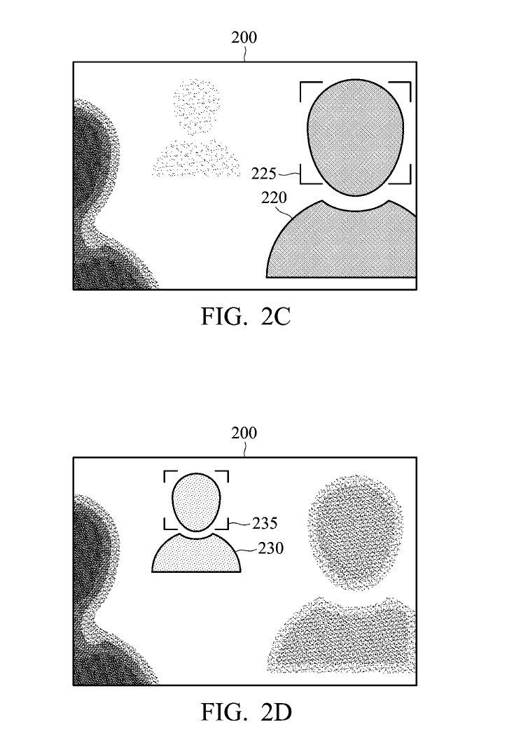

FIGS. 2A˜2D are diagrams illustrating the refocusing operations in an image according to an embodiment of the invention. Referring to both FIG. 1 and FIG. 2A, the image 200 may be an instantly-retrieved image by the image capture unit 150 or a pre-stored photograph in the memory unit 120. Then, the processor 110 may analyze the retrieved image 200 to determine multiple target objects (e.g. human faces 215, 225 and 235) from the image 200. For example, the processor 110 may use known face detection techniques to recognize human faces (e.g. human faces 215, 225 and 235) in the image 200. Alternatively, the processor 110 may also use known object recognition techniques to identify different objects in the image 200. Since the users 210, 220, and 230 may be located at different depth distances within the scene (or say from the lens of the image capture unit 150), the processor 110 may estimate a depth map (e.g. a grey level map of luminance values from 0 to 255) corresponding to the image 200, thereby estimating the depth distance of each target object in the image 200. In another embodiment, the depth distances can be determined from stereoscopic images captured by a plenoptic camera with “light field” technology and an all-in-focus function.

After determining corresponding depth distances, the processor 110 may calculate a ranking based on the estimated depth distances of the target objects, and automatically focus each of the target objects in a specific display order associated with the calculated ranking of the estimated depth distances of the target objects to alter the focus on different target objects. For example, given that the human faces 215, 225 and 235 have corresponding first depth distance d1, second depth distance d2, and third depth distance d3, and the ranking of the depth distances can be expressed as: d1>d2>d3, where the largest value of the depth distance (e.g. with a smallest grey level in the depth image) indicates that the corresponding target object is located at the farthest place of the scene, and the smallest value of the depth distance (e.g. with a largest grey level in the depth image) indicates that the corresponding target object is located at the nearest place of the scene. Accordingly, the processor 110 may focus on the human face 215 first, as illustrated in FIG. 2B. Then, the processor 110 may switch focus on the human face 225, as illustrated in FIG. 2C. Last, the processor 110 may switch focus again on the human face 235, as illustrated in FIG. 2D. In short, the display screen 140 provides viewing of the image 200 with focus switching from the human faces 215, 225 and 235 in rotation order with desired viewing effect. The refocusing operations are executed sequentially in rotation. In some embodiments, only the focused target object is the clearest object in the image 200 during the refocusing procedure, and remaining portions of the image 200 may be blurred. In other embodiments of the invention, the focus order and viewing effect may be in any other fashion predefined or specified by the user. For example, the focus order may be designated by position (left to right or right to left, etc.), by object size (large to small or small to large, etc.) or by object type (human, animal, etc.) the viewing effect may be enhancing focused target object and blurring non-focused portions within the image 200 (i.e. portions except the focused target object), fish eye effect on the focused target, or applying predetermined or user specified filter on the focused target object/non-focused portions, etc.

In another embodiment, the electronic device 100 may further comprise a motion detection unit (not shown in FIG. 1), such as an accelerometer and a gyroscope, for detecting motion information (e.g. acceleration and angle speed) of the electronic device. The processor 110 may retrieve the detected motion information from the motion detection unit, and detect any shaking motion of the electronic device 100. When a shaking motion of the electronic device 100 is detected, the processor 110 may refocus on a next one of the target objects in the display order. Accordingly, a user may shake the electronic device 100 to switch the focused target object in the image.

In yet another embodiment, the display screen 140 may comprise a touch-sensitive module capable of detecting user inputs (e.g. swiping touch actions) on the display screen 140, and the focused target object can be altered manually. For example, a user may use his/her finger or a stylus to swipe or tap the display screen 140, and thus the display screen 140 may detect one or more swiping touch actions. Then, the processor 110 may switch to the next target object in display order (i.e. in the rotation) and focus on the switched target object in response to detecting a user input. In the aforementioned embodiments, assuming the resolution of the image 200 is larger than that of the display screen 140, the processor 110 may further adjust the position of display area within the image 200, so that the focused target object is located at the center of the display screen 140. In addition, during the transition from one to another focused target object, the image can be blurred until the focused target object is moved to the center of the display screen. For one having ordinary skill in the art, it is appreciated that various image effects can be illustrated during the transition, and the invention is not limited to the aforementioned image effects.

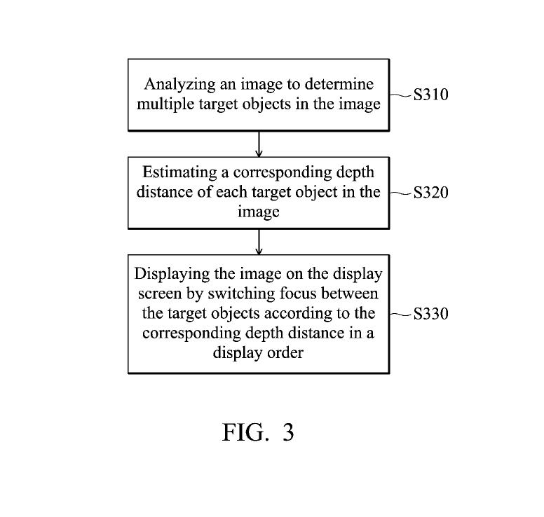

FIG. 3 is a flow chart illustrating the automatic image refocusing method according to an embodiment of the invention. Referring to both FIGS. 1˜3, in step S310, the processor 110 may analyze an image (e.g. image 200) to determine multiple target objects (e.g. human faces 215, 225 and 235) in the image. For example, the determined target objects may be human faces, which are recognized from the image by using face detection techniques. Other object detection/identification techniques known in the art may also be applied to embodiments of the invention. In step S320, the processor may estimate the corresponding depth distances of the target objects in the image. For example, the processor 110 may generate a corresponding depth map of the image, thereby estimating the corresponding depth distance of each target object. In step S330, the processor 110 may display the image on the display screen by switching focus between the target objects according to the corresponding depth distances in a display order. For example, the aforementioned display order may indicate that each of the target objects is displayed in a rotation. Additionally, the user may also change the target object to be focused by sending a user input on the display screen (i.e. a touch-sensitive screen).

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automatic image refocusing method for use in an electronic device comprising at least a display screen, the automatic image refocusing comprising:
analyzing an image to determine multiple target objects in the image;
estimating a corresponding depth distance of each target object in the image; and
displaying the image on the display screen by switching focus between target objects according to the corresponding depth distances in a display order.

2. The image adjusting method as claimed in claim 1, wherein the analyzing step comprises:
performing face detection on the image to determine human faces as the target objects from the image.

3. The image adjusting method as claimed in claim 1, further comprising:
determining a depth map of the image; and
estimating the corresponding depth distance of each target object according to the depth map.

4. The image adjusting method as claimed in claim 1, wherein the display order is determined according to ranking of the corresponding depth distances of the target objects.

5. The image adjusting method as claimed in claim 1, further comprises:
detecting a motion of the electronic device by a motion detection unit of the electronic device; and
in response to a motion is detected, displaying a next one of the target objects in the display order.

6. The image adjusting method as claimed in claim 1, further comprising:
enlarging a region of the focused target object; and
displaying the enlarged region at the center of the display screen.

7. The image adjusting method as claimed in claim 1, wherein the display screen is a touch-sensitive screen, and the image adjusting method further comprises:
selecting one of the target objects by tapping on the touch screen manually by a user; and
switching focus on the selected target object.

8. The image adjusting method as claimed in claim 1, further comprises:
rotating and focusing between the target objects by detecting user inputs on the display screen.

9. The image adjusting method as claimed in claim 1, further comprising:
applying viewing effect to the target object being focused.

10. An electronic device, comprising:
a display screen, configured to display an image; and
a processor configured to analyze an image to determine multiple target objects in the image, estimate corresponding depth distances of the target objects in the image, and switch focus of the image between the target objects according to the corresponding depth distances in a display order.

11. The electronic device as claimed in claim 10, wherein the processor is further configured to perform face detection to the image to determine human faces as the target objects from the image.

12. The electronic device as claimed in claim 10, wherein the processor is further configured to determine a depth map of the image, and estimates the corresponding depth distance of each target object according to the depth image.

13. The electronic device as claimed in claim 10, wherein the display order is determined according to a ranking of the corresponding depth distances of the target objects.

14. The electronic device as claimed in claim 10, further comprising:
a motion detection unit, configured to detect a motion of the electronic device, wherein in response to a motion of the electronic device is detected by the motion detection unit, the processor switches focus to a next one of the target objects in the display order.

15. The electronic device as claimed in claim 10, wherein the processor is further configured to enlarge a region of the focused target object, and displays the enlarged region at the center of the display screen.

16. The electronic device as claimed in claim 10, wherein the display screen is a touch-sensitive screen for receiving a user input, and the processor further selects one of the target objects and focuses on the selected target object according to the user input.

17. The electronic device as claimed in claim 10, wherein the display screen is a touch-sensitive screen for receiving a user input, and the processor is further configured to switch focus between the target objects according to the user input.

18. The electronic device as claimed in claim 10, wherein the display order is predetermined or specified by a user.

19. The electronic device as claimed in claim 10, wherein the processor is further configured to apply viewing effect to the target object being focused.
